(19) United States
(12) Patent Application Publication
(10) Pub. No.: US 2014/0081720 A1
(43) Pub. Date: Mar. 20, 2014

(54) METHOD AND SYSTEM FOR PROCESSING COUPONS IN A NEAR FIELD TRANSACTION

(71) Applicant: Willianto WU, (US)

(72) Inventor: Wilianto WU, Singapore (SG)

(73) Assignee: MASTERCARD INTERNATIONAL INCORPORATED, Purchase, NY (US)

(21) Appl. No.: 13/622,640

(22) Filed: Sep. 19, 2012

(51) Int. Cl. G06Q 30/00

(52) U.S. Cl. 705/14.1

(57) ABSTRACT

A method for processing a coupon in a near field transaction includes: receiving, by near field communication, payment details and a coupon record; identifying if the coupon record is valid by comparing the coupon record to a stored configuration profile; modifying the transaction amount for the transaction based on a modifier in the coupon record; and submitting an authorization request for the transaction with the modified transaction amount and the received payment details. A method for applying a coupon in a near field transaction includes: storing payment details in a contactless application; receiving coupon data and coupon details for the coupon; displaying the coupon details to a user; receiving an indication of selection of the coupon by the user; storing the coupon data in the contactless application; and transmitting, by near field communication, the payment details and coupon data in the contactless application for use in a financial transaction.

### FIELD

The present disclosure relates to the processing of coupons in a near field transaction, specifically the processing of coupons transmitted via near field communication prior to the submission of an authorization request in a financial transaction.

### BACKGROUND

In recent times, coupons, deals, offers, and other discounts have become a large part of marketing efforts by merchants and manufacturers. Offering consumers a coupon can result in an increase in revenue, and a repeat customer that could result in even greater gains over a period of time. Coupons also provide an avenue of exposure of a merchant or manufacturer to consumers that may not have been aware of the merchant or manufacturer prior to receiving the coupon, or may convince an apprehensive consumer to transact with the entity when they otherwise may not have.

Traditionally, coupons and other deals often came in the form of paper coupons often with machine-readable codes included in newspapers and magazines. To redeem such a coupon, a consumer would have to obtain a copy of the newspaper or magazine, locate the coupon, remove or “clip” the coupon, take it to the merchant, and then present it to the merchant as part of the checkout process. However, because of the large number of steps, consumers could often forget or misplace coupons prior to their being used. In order to make the process easier for consumers, and due to the prevalence of smart phones and other mobile devices, some merchants and manufacturers have begun to use electronic coupons. These electronic coupons would contain machine-readable codes and could be stored on the mobile device and used similar to traditional paper coupons. However, much like traditional coupons, consumers often must open an application program on their mobile device, pull up the coupon to be used, present it to the merchant, and then proceed to present their payment information for funding the transaction. Such a process involving the separate presentation of a coupon in addition to payment details can be cumbersome and take significant time for both consumers and merchants.

The presentation of an electronic coupon on a mobile device followed by the presentation of payment information can be even more time consuming and frustrating for consumers if the mobile device itself is also used for the presentation of payment information. As consumers begin to use their smart phones and other mobile devices more and more, electronic wallets have become an increasingly popular method for transmitting payment information. Electronic wallets securely store payment card information on a mobile device, and transmit the information to a point of sale terminal via near field communication (NFC), typically using radio frequency. Such electronic wallets typically are used via an application program on a mobile device. A consumer required to switch between two application programs, in instances where a coupon is presented, may result in a significant amount of time and inconvenience to both the consumer and the merchant.

Thus, there is a need for a technical solution to processing a coupon for a transaction using near field communication that can increase the efficiency of the presentation and decrease the time to initiate the transaction.

### SUMMARY

The present disclosure provides a description of a systems and methods for limiting the distribution of coupons to consumers based on risk profiles.

A method for processing a coupon in a near field transaction includes: storing, in a configuration database, a plurality of configuration profiles, wherein each configuration profile includes at least a product identifier and a target identifier; storing, in a transaction database, transaction details for a financial transaction to be processed, wherein the transaction details includes at least a transaction amount; receiving, by near field communication, payment details and at least one coupon record, wherein the coupon record includes at least a product identification, a target identification, and a transaction modifier; identifying, by a processing device, at least one valid coupon record, wherein each valid coupon record is a coupon record of the at least one coupon record where the respective product identification and target identification correspond to the product identifier and target identifier for a configuration profile of the plurality of configuration profiles; modifying, by the processing device, the transaction details for the financial transaction to be processed by modifying the transaction amount based on the transaction modifier for each valid coupon record of the at least one valid coupon record; and transmitting, by a transmitting device, an authorization request for the financial transaction, wherein the authorization request includes at least the received payment details and the modified transaction amount.

A method for applying a coupon in a near field transaction includes: storing, in a contactless application, payment details for funding a financial transaction to be processed; receiving, by a receiving device, coupon information for a coupon, wherein the coupon information includes at least coupon data and coupon details, the coupon data including at least a product identifier, a target identifier, and a transaction modifier; storing, in a database, the received coupon information; displaying, by a display device, at least the coupon details to a user; receiving, by an input device, an indication of selection of the coupon to be applied to the financial transaction to be processed; storing, in the contactless application, at least the coupon data upon receiving the indication of selection of the coupon; and transmitting, by near field communication, at least the payment details and the coupon data stored in the contactless application for use in the financial transaction to be processed.

A system for process a coupon in a near field transaction includes a configuration database, a transaction database, a receiving device, a processing device, and a transmitting device. The configuration database is configured to store a plurality of configuration profiles, wherein each configuration profile includes at least a product identifier and a target identifier. The transaction database is configured to store transaction details for a financial transaction to be processed, wherein the transaction details includes at least a transaction amount. The receiving device is configured to receive, by near field communication, payment details and at least one coupon record, wherein the coupon record includes at least a product identification, a target identification, and a transaction modifier. The processing device is configured to: identify at least one valid coupon record, wherein each valid coupon record is a coupon record of the at least one coupon record where the respective product identification and target identification correspond to the product identifier and target identifier for a configuration profile of the plurality of configuration profiles, and modify the transaction details for the financial transaction to be processed by modifying the transaction amount based on the transaction modifier for each valid coupon record of the at least one valid coupon record. The transmitting device is configured to transmit an authorization request for the financial transaction, wherein the authorization request includes at least the received payment details and the modified transaction amount.

A system for applying a coupon in a near field transaction includes a contactless application, a receiving device, a database, a display device, an input device, a processing device, and a transmitting device. The contactless application is configured to store payment details for funding a financial transaction to be processed. The receiving device is configured to receive coupon information for a coupon, wherein the coupon information includes at least coupon data and coupon details, the coupon data including at least a product identifier, a target identifier, and a transaction modifier. The database is configured to store the received coupon information. The display device is configured to display at least the coupon details to a user. The input device is configured to receive an indication of selection of the coupon to be applied to the financial transaction to be processed. The processing device is configured to store, in the contactless application, at least the coupon data upon receiving the indication of selection of the coupon. The transmitting device is configured to transmit, by near field communication, at least the payment details and the coupon data stored in the contactless application for use in the financial transaction to be processed.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for the processing of coupons in a near field transaction in accordance with exemplary embodiments.

FIG. 2 is a block diagram illustrating a mobile device for use in the system of FIG. 1 in accordance with exemplary embodiments.

FIG. 3 is a block diagram illustrating a point of sale for use in the system of FIG. 1 in accordance with exemplary embodiments.

FIG. 4 is a block diagram illustrating a configuration database of the point of sale of FIG. 3 in accordance with exemplary embodiments.

FIG. 5 is a block diagram illustrating a coupon database of the mobile device of FIG. 2 in accordance with exemplary embodiments.

FIG. 6 is a flow chart illustrating a method for processing coupon in a near field financial transaction by the point of sale of FIG. 3 in accordance with exemplary embodiments.

FIGS. 7A and 7B are illustrations of a graphical user interface of the mobile device of FIG. 2 in accordance with exemplary embodiments.

FIG. 8 is a block diagram illustrating system architecture of a computer system in accordance with exemplary embodiments.

FIG. 9 is a flow chart illustrating an exemplary method for processing a coupon in a near field transaction in accordance with exemplary embodiments.

FIG. 10 is a flow chart illustrating an exemplary method for applying a coupon in a near field transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing a Coupon in a Near Field Transaction

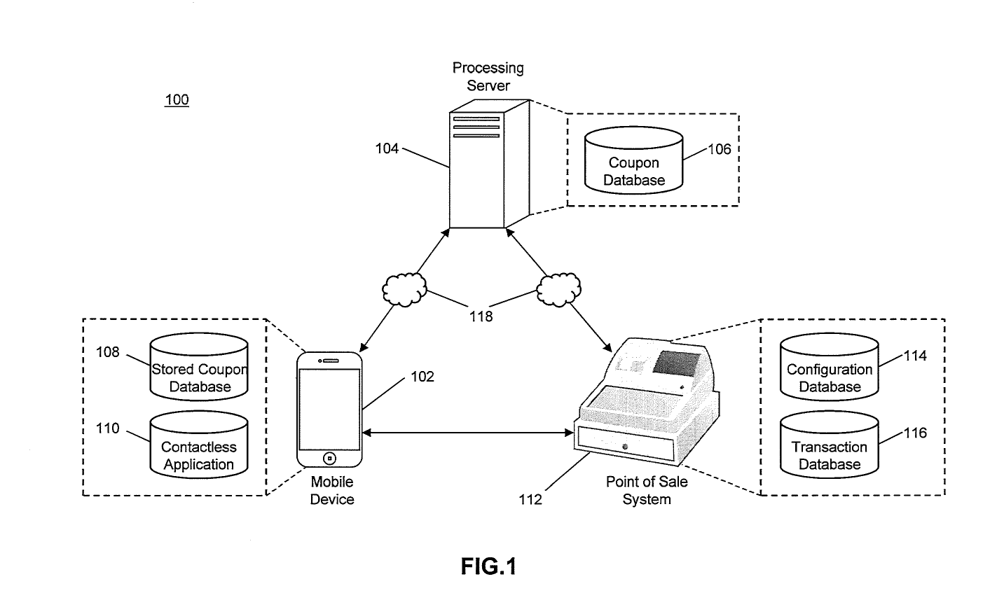

FIG. 1 is a block diagram illustrating a system 100 for processing a coupon in a financial transaction utilizing near field communication (NFC).

The system 100 may include a mobile device 102. The mobile device 102 may be any type of mobile device suitable for performing the functions as disclosed herein, such as a cellular phone, a smart phone, a tablet computer, etc. The mobile device 102 may be configured to transmit data via near field communication (NFC). Methods for transmitting data via NFC will be apparent to persons having skill in the relevant art, and may include communicating pursuant to the International Organization for Standardization (IOS) and International Electrotechnical Commission (IEC) joint standard IOS/IEC 14443. The mobile device 102, discussed in more detail below, may include an electronic wallet an application program. An electronic wallet may be a program configured to store payment details for a plurality of payment cards for transmission via NFC for funding a financial transaction. The electronic wallet may store the payment details using a contactless application 110. The contactless application 110 may be any type of data storage for transmission as will be apparent to persons having skill in the relevant art, such as a non-secure element (e.g., memory of the mobile device 102), or a secure element (SE), which may be in any form factor suitable for performing the functions as disclosed herein, such as an embedded chip, a subscriber identity module (SIM), a Secure Digital (SD) card, etc. Methods for the use of electronic wallets for transmission of payment details to a point of sale via NFC will be apparent to persons having skill in the relevant art.

A user of the mobile device 102 may use the application program to communicate with a processing server 104. The processing server 104 may include a coupon database 106. The coupon database 106 may include a plurality of coupons that may be presented to the user of the mobile device 102 for “clipping” (e.g., receiving and saving in the mobile device, etc.) for future presentation in a financial transaction. The processing server 104 may transmit coupon details for the plurality of coupons to the mobile device 102 via a network 118. The network 118 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The mobile device 102 may display the received plurality of coupons to the user for clipping and/or for use in a financial transaction. It will be apparent to persons having skill in the relevant art that coupons transmitted to the mobile device 102 stored in the coupon database 106 may be selected or transmitted based on a variety of criteria. For example, coupons may be presented based on distance to a participating merchant, expiration date, coupon value, merchant name, user preferences, user social network data, coupon start date, etc. The user of the mobile device 102 may select a coupon for use in a future financial transaction. The mobile device 102 may store information related to the selected coupon in a coupon database 108, discussed in more detail below.

The user of the mobile device 102 may then visit a location of a merchant and engage in a financial transaction. Information related to the financial transaction, such as goods or services being transacted, may be entered (e.g., by an employee, via scanning of machine-readable codes, etc.) on a point of sale system 112. The point of sale system 112 may store transaction information for the transaction in a transaction database 116. The transaction information may include at least a transaction amount. Additional information that may be included in the transaction database 116 will be apparent to persons having skill in the relevant art and may include product information, transaction time and/or date, merchant identification, industry information, etc.

Once the transaction has been initiated on the point of sale system 112 of the merchant, the user of the mobile device 102 may select a coupon stored in the stored coupon database 108 for presentation along with payment details. The mobile device 102 may transmit coupon data, discussed in more detail below, to the contactless application 110, such that the contactless application 110 includes both payment details and coupon data. The mobile device 102 may then transmit the information included in the contactless application 110 to the point of sale system 112 via NFC. The point of sale system 112, discussed in more detail below, may receive the information from the contactless application 110 using NFC. The point of sale system 112 may compare the received coupon data with configuration data stored in a configuration database 114, discussed in more detail below, to determine the validity of the transmitted coupon. If the coupon is valid, then the point of sale system 112 may modify the transaction amount stored in the transaction database 116 for the transaction based on the coupon. The once the transaction amount has been modified, the point of sale system 112 may process the financial transaction using the payment information received via NFC. Processing of the financial transaction may include submitting an authorization request for the modified transaction amount to a payment processing system, such as a financial transaction processing agency (e.g., MasterCard®, VISA®, etc.). Methods for submitting authorization requests and processing financial transactions will be apparent to persons having skill in the relevant art.

### Mobile Device

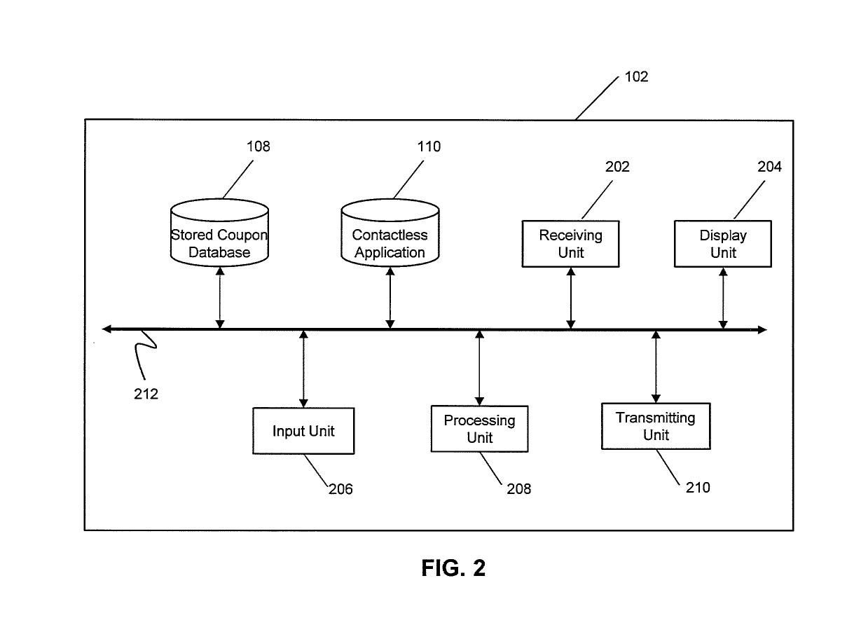

FIG. 2 illustrates an embodiment of the mobile device 102 for use in the system 100. The mobile device 102 may include the stored coupon database 108, the contactless application 110, a receiving unit 202, a display unit 204, an input unit 206, a processing unit 208, and a transmitting unit 210. Each of the components may be configured to communicate via a bus 212. Suitable types and configurations of the bus 212 will be apparent to persons having skill in the relevant art.

Data stored in the stored coupon database 108 and the contactless application 110 (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc., and each does not have to be a single descret device, but rather can be co-located or spread over any number of interconnected devices. Suitable configurations and database storage types will be apparent to persons having skill in the relevant art. The databases may each be a single database, or may comprise multiple databases which may be interfaced together (e.g., physically or via a network, such as the network 116).

The receiving unit 202 may be configured to receive (e.g., from the processing server 104) a plurality of available coupons. In some embodiments, the receiving unit 202 may receive available coupons in response to a request transmitted to the processing server 104 (e.g., by the transmitting unit 210), such as a request including identifying information identifying a user of the mobile device 102. Identifying information may be used, for example, to receive available coupons tailored to the individual user, such as based on user preferences, previously redeemed coupons, geographic location of the mobile device 102, etc.

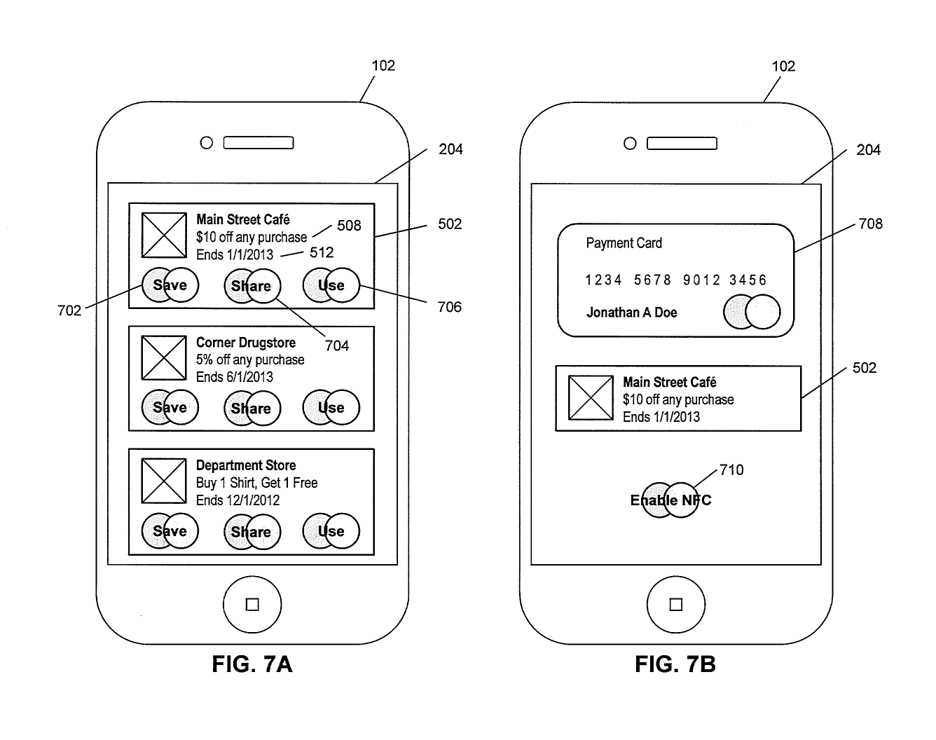

The display unit 204 may be configured to display the received available coupons to a user. The display unit 204 may be any type of display suitable for performing the functions as disclosed herein, such as a liquid crystal display (LCD), a light emitting diode (LED) display, a capacitive touch display, etc. The display unit 204 may be further configured to display saved coupons and payment methods stored in an electronic wallet application program, such as illustrated in the graphical user interfaces of FIGS. 7A and 7B. The input unit 206 may be configured to receive input from a user of the mobile device 102 indicating at least one coupon to be applied in a transaction (e.g., a current transaction or saved for a future transaction), and a payment method to be used for funding of the transaction. Suitable methods of receiving input from a user will be apparent to persons having skill in the relevant art and may include mouse, keyboard, touch pad, capacitive touch display, click wheel, etc.

The processing unit 208 may be configured to identify a coupon indicated by the input of the user and store the corresponding coupon information in the stored coupon database 108. The coupon information may include coupon data and coupon details. Coupon data may include data corresponding to the coupon for the identification of the coupon by the merchant point of sale system 112, such as a product identifier, a target identifier, and a transaction modifier, described in more detail below. Coupon details may include information corresponding to the coupon for presentation to a user (e.g., via the display unit 204), such as coupon value, coupon name, merchant name, and expiration date, discussed in more detail below.

The processing unit 208 may be further configured to store, in the contactless application 110, payment details for at least one funding source, such as a payment card (e.g., credit card, debit card, etc.), checking account, or other financial account as will be apparent to persons having skill in the relevant art. The contactless application may be any type of data storage suitable for performing the functions as disclosed herein, such as non-secure storage (e.g., memory) or a secure element (SE) (e.g., a subscriber identity module (SIM) card, a Secure Digital (SD) card, an embedded chip, etc.). The processing unit 208 may also be configured to store in the contactless application 110 coupon data for a coupon indicated by the user for application to a transaction, based on input received by the input unit 206. When the input unit 206 received input from a user indicating a selected coupon and payment method for a financial transaction, the transmitting unit 210 may be configured to transmit, via NFC, the payment details and coupon data included in the contactless application 110 for processing in a financial transaction (e.g., by the point of sale system 112). The receiving unit 202 may be further configured to receive (e.g., from the processing server 104, via the network 118, or the point of sale system 112, via NFC) an indication of invalidity of the selected coupon. The processing unit 208 may then cause the display unit 204 to display, to the user, that the selected coupon is invalid, as discussed in more detail below. The input unit 206 may then receive an indication from the user selecting a different coupon to be applied to the transaction, or confirmation to proceed with the financial transaction without an applied coupon, which may be transmitted to the point of sale system 112 by the transmitting unit 210. In some embodiments, the receiving unit 202 may receive an indication of invalidity of a coupon following the processing of the financial transaction by a financial transaction processing agency (e.g., the processing server 104).

### Point of Sale System

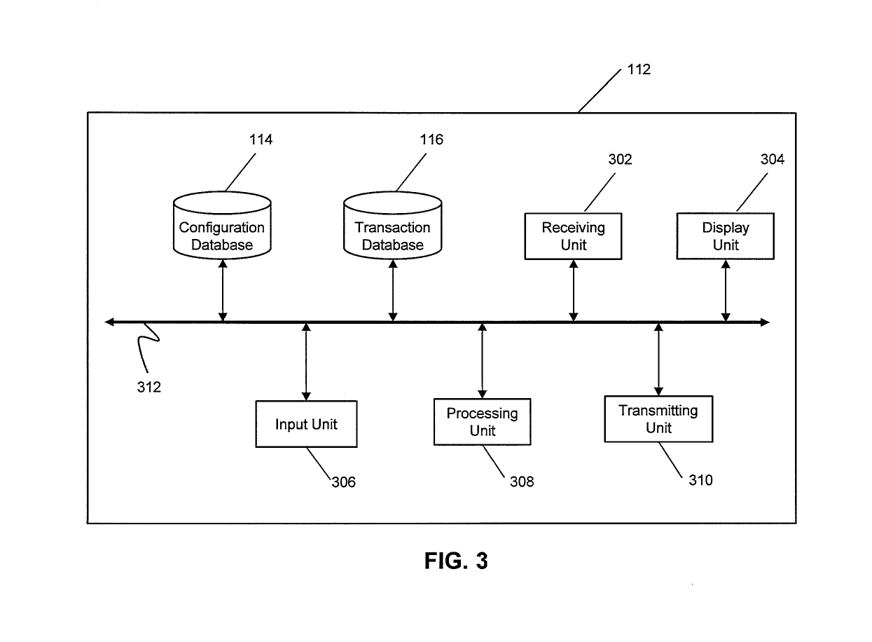

FIG. 3 is an illustration of an embodiment of the point of sale system 112 of the system 100 for processing a coupon in a near field transaction. The point of sale system 112 may include the configuration database 114, the transaction database 116, a receiving unit 302, a display unit 304, an input unit 306, a processing unit 308, and a transmitting unit 310. Each of the components may be configured to communicate via a bus 312. Suitable types and configurations of the bus 312 will be apparent to persons having skill in the relevant art.

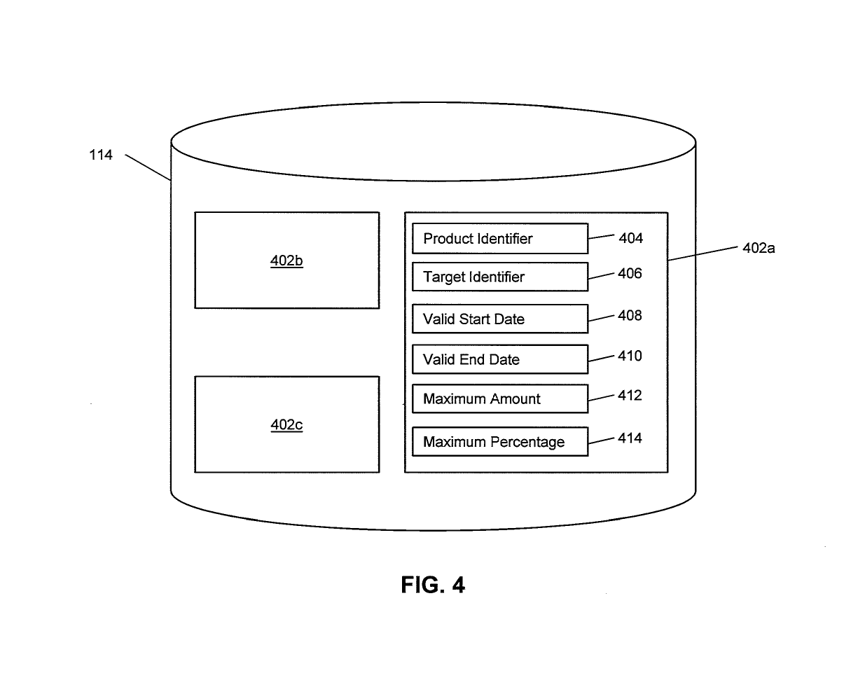

The receiving unit 302 may be configured to receive configuration information for processing coupons which may be stored in the configuration database 114 (e.g., by the processing unit 308). Configuration information and the configuration database 114 are discussed in more detail below with respect to FIG. 4. The input unit 306 may be configured to receive input of transaction details for a financial transaction. The input unit 306 may be any type of input suitable for performing the functions as disclosed herein, such as a scanner for reading machine-readable codes (e.g., bar codes), a keyboard, a mouse, a capacitive touch display, or a combination thereof. The processing unit 308 may be configured to store the transaction details in the transaction database 116, wherein the transaction details include at least a transaction amount.

The display unit 304 may be configured to display (e.g., to a user) the transaction details stored in the transaction database 116, such as product information (e.g., product name or title, product price, product quantity) and transaction amount. Once all products (e.g., goods, services, etc.) have been entered in the transaction database 116 via the input unit 306 and the processing unit 308, the display unit 304 may indicate that payment details may be accepted by the point of sale system 112. Methods for indicating to a consumer that payment details may be accepted at a point of sale will be apparent to persons having skill in the relevant art.

The receiving unit 302 may be configured to receive payment and coupon data for the financial transaction via near field communication (NFC). Methods for receiving data via NFC will be apparent to persons having skill in the relevant art. The received payment data may include information corresponding to a payment source (e.g., a payment card, such as a credit card), such as an account number, for the funding of the financial transaction. The coupon data, discussed in more detail below, may include at least a product identifier, a target identifier, and a transaction modifier. The processing unit 308 may be configured to compare the received coupon data with the configuration information stored in the configuration database 114, as discussed in more detail below, to determine the validity of the coupon. In an exemplary embodiment, the processing unit 308 may determine the validity of the coupon without utilizing the network 118 such that a coupon may be applied to the financial transaction using NFC without necessarily communicating to a server (e.g., the processing server 104) to obtain additional information. This can be done by reviewing values in the coupon code against their expected or acceptable values, by check sums, etc.

If the coupon is determined to be invalid, the transmitting unit 310 may be configured to transmit to the processing server 104 (e.g., via the network 118) or to the mobile device 102 (e.g., via NFC) indication of the coupon as being invalid. In one embodiment, the point of sale system 112 may process the financial transaction upon transmitting the indication of the coupon as being invalid. In another embodiment, the financial transaction may not be processed until the receiving unit 302 receives confirmation (e.g., from the mobile device 102 or the processing server 104) to proceed with the financial transaction absent use of the coupon. In an alternative embodiment, the user of the mobile device 102 may notify a user of the point of sale system 112 to proceed with the transaction absent the coupon. In such an embodiment, the user of the point of sale system 112 may input, via the input unit 306, an instruction to proceed with processing the transaction.

If the coupon is determined to be valid, the processing unit 308 may calculate a new transaction amount based on the transaction modifier of the valid coupon. For example, if the transaction modifier is 10% off, the new transaction amount may be the transaction amount stored in the transaction database 116 less 10 percent. Methods for calculating a transaction amount based on transaction modifiers of coupons will be apparent to persons having skill in the relevant art. In one embodiment, the processing unit 308 may store the new transaction amount as the transaction amount in the transaction details of the transaction database 116. To process the financial transaction, the transmitting unit 310 may be configured to submit an authorization request for the financial transaction (e.g., to a financial transaction processing agency, such as the processing server 104).

The receiving unit 302 may be configured to receive an authorization response for the financial transaction. The authorization response may indicate to the point of sale system 112 whether the transaction has been approved or denied. The user of the point of sale system 112 may then finalize the transaction accordingly. In some embodiments, if the transaction is approved, the transmitting unit 310 may be configured to transmit (e.g., to the processing server 104 or the mobile device 102) the redemption of the coupon, such as for updating the availability of a coupon for redemption.

### Configuration Database

FIG. 4 is an illustration of the configuration database 114 of the point of sale system 112 for storing configuration information for use in determining the validity of a coupon in a near field financial transaction. The configuration database 114 may contain a plurality of configuration profiles 402, illustrated in FIG. 4 as configuration profiles 402a, 402b, and 402c. Each configuration profile 402 may include at least a product identifier 404, a target identifier 406, a valid start date 408, a valid end date 410, a maximum amount 412, and a maximum percentage 414. Each configuration profile 402 may be associated with a coupon such that the configuration profile 402 may be used, as discussed in more detail below, to determine the validity of the corresponding coupon.

The product identifier 404 may be a unique value associated with a coupon for the purposes of identification of the coupon. Types of values suitable for use as the product identifier 404 will be apparent to persons having skill in the relevant art, such as an integer, which may further be randomly generated and/or identified (e.g., by the processing server 104) to the corresponding coupon.

The target identifier 406 may be a unique value associated with a merchant or coupon issuer, which may be suitable for identifying the entity that honors the redemption of the coupon. In one embodiment, the configuration profile 402 may include a separate merchant identifier and coupon issuer identifier in place of the target identifier 406. In such an embodiment, only one of the merchant and coupon issuer identifiers may have a value (e.g., the other may be set to null, be zero, etc.), as to indicate if the coupon may be redeemed at a specific merchant (e.g., if the merchant identifier is nonzero) or may be redeemed at a group of merchants (e.g., if the coupon issuer identifier is zero). In other embodiments, the target identifier 406 may indicate if the coupon is redeemable at a specific merchant or by groups of merchants by an association of the target identifier to a merchant or a coupon issuer. In one embodiment, the target identifier 406 may be an integer value of up to 16 digits. Suitable values for use as the target identifier 406 will be apparent to persons having skill in the relevant art.

The valid start date 408 may indicate a date and/or time that the corresponding coupon becomes valid, such that if an attempted use of the coupon is made prior to the date, the point of sale system 112 may identify the coupon as being invalid. For example, the configuration profile 402 may include a valid start date 408 for a future time in order to have the point of sale system 112 properly configured prior to an upcoming promotion by a merchant or manufacturer. The valid end date 410 may indicate a date and/or time that the corresponding coupon becomes invalid (e.g., expires), such that if an attempted use of the coupon is made after the valid end date 410, the point of sale system 112 may identify the coupon as being invalid. The valid start date 408 and the valid end date 410 may be represented by in any format suitable for use for performing the functions as disclosed herein, such as based on the International Standard for Organization (ISO) 8601 standard, a UNIX timestamp, etc.

The maximum amount 412 may be a value indicating the maximum currency amount for which the corresponding coupons may be valid, or be a global indicator as to the maximum value of any coupon. The maximum percentage 414 may be a value indicating the maximum percentage discount that the corresponding coupon may be valid for. In an exemplary embodiment, the value for at least one of the maximum amount 412 and maximum percentage 414 may always be zero. In one embodiment, the value for both the maximum amount 412 and the maximum percentage 414 may be zero to indicate that the corresponding coupon refers to a free gift (e.g., a free product, buy one get one free, buy two get one free, etc.). It will be apparent to persons having skill in the relevant art that in such an embodiment the configuration profile 402 may include at least one additional field to indicate the value or an identifier of the corresponding product or service. Each configuration profile 402 may include additional information as will be apparent to persons having skill in the relevant art based on the application, coupon, use, etc. For example, each configuration profile 402 may include a minimum transaction amount, a maximum transaction amount, a frequency of use, a coupon quantity, etc.

### Stored Coupon Database

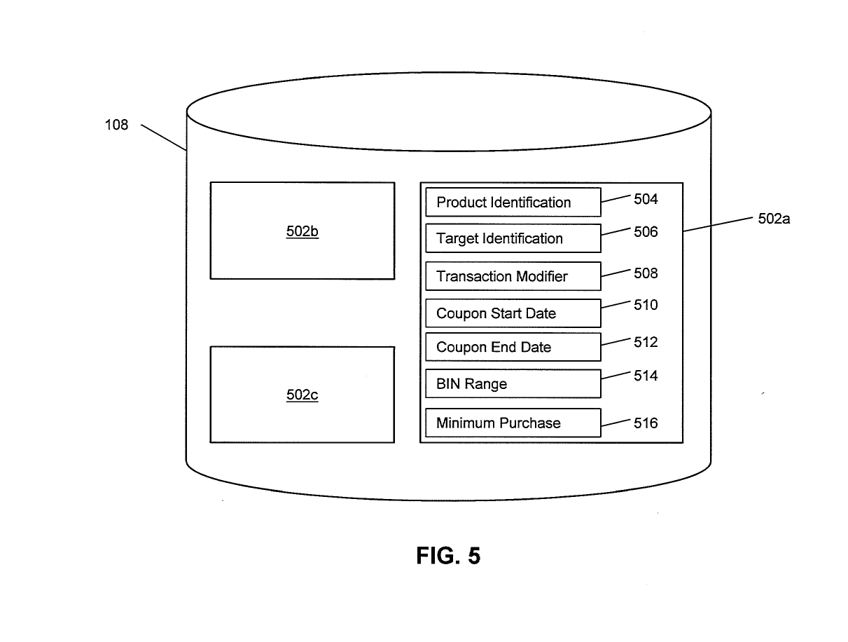

FIG. 5 is an illustration of the stored coupon database 108 of the mobile device 102 for the storing of coupons to be applied to a near field transaction. The stored coupon database 108 may include a plurality of coupons 502, illustrated as coupons 502a, 502b, and 502c. Each coupon 502 may include at least a product identification 504, a target identification 506, a transaction modifier 508, a coupon start date 510, a coupon end date 512, a bank identification number (BIN) range 514, and a minimum purchase 516. Additional fields that may be included in each coupon 502 in the stored coupon database 108 will be apparent to persons having skill in the relevant art.

The product identification 504 may be a unique value associated with the coupon 502 for identification of the coupon. The product identification 504 may correspond to the product identifier 404 in a configuration profile 404 such that the point of sale system 112 may identify the coupon 502 as an existing coupon that may be valid. The target identification 506 may be a unique value corresponding to a merchant or coupon issuer, which may correspond to the target identifier 406 in a configuration profile 404. Values suitable as the target identification 506 may correspond to those suitable for use as the target identifier 406, as discussed above.

The transaction modifier 508 may be an indication of how a transaction amount for a financial transaction may be modified based on the coupon 502. In some embodiments, the transaction modifier 508 may include multiple fields (e.g., discount amount, discount percentage, gift identifier, etc.). The transaction modifier 508 may indicate the coupon 502 as being for a value discount (e.g., $5 off), a percentage discount (e.g., 5% off), a free gift (e.g., buy one get one free), or any other type of modification as will be apparent to persons having skill in the relevant art. The coupon start date 510 and the coupon end date 512 may be date and/or time values corresponding to when the coupon 502 may be valid for use. Each of the coupon start date 510 and the coupon end date 512 may correspond to the valid start date 408 and valid end date 410, respectively, to determine the validity of the coupon 502. In some embodiments, at least one of the coupon start date 510 and the coupon end date 512 may include no value or a value to indicate that the corresponding coupon 502 can be used starting at any time (e.g., no coupon start date 510) or does not expire (e.g., no coupon end date 512). Suitable formats for use as the dates will be apparent to persons having skill in the relevant art.

The BIN range 514 may be a value associated with a payment method. In an exemplary embodiment, the BIN range 514 may be a value indicating a type of payment card (e.g., a credit card) that may be used in order for the coupon 502 to be valid. In such an embodiment, the type of value used as the BIN range 514 may be dependent on the application. For example, the BIN range 514 may be a single integer, which may indicate a specific issuer network (e.g., a BIN range 514 of 4 for VISA®). In some embodiments, a coupon 502 may include multiple BIN ranges 514, such as for indicating multiple payment methods eligible for use to redeem the corresponding coupon 502. It will be apparent to persons having skill in the relevant art that the BIN range 514 may be optional.

The minimum purchase 516 may be a value indicating the minimum transaction amount that a financial transaction must be in order for the coupon 502 to be valid for the transaction. For example, the minimum purchase 516 may be 20 for a coupon 502, which may indicate that the coupon 502 may only be redeemable for transactions of at least $20 or more. A value of zero may as the minimum purchase 516 may indicate that the coupon 502 may be used in a financial transaction for any transaction amount.

Additional fields may be included in each coupon 502 as will be apparent to persons having skill in the relevant art. For example, a coupon 502 may include a maximum transaction amount, a name or title, an image (e.g., for display of the coupon 502 to a consumer), terms and conditions, a description, a category (e.g., merchant category, industry category, discount category, etc.), a merchant location, etc.

### Method for Processing a Coupon in a Near Field Transaction

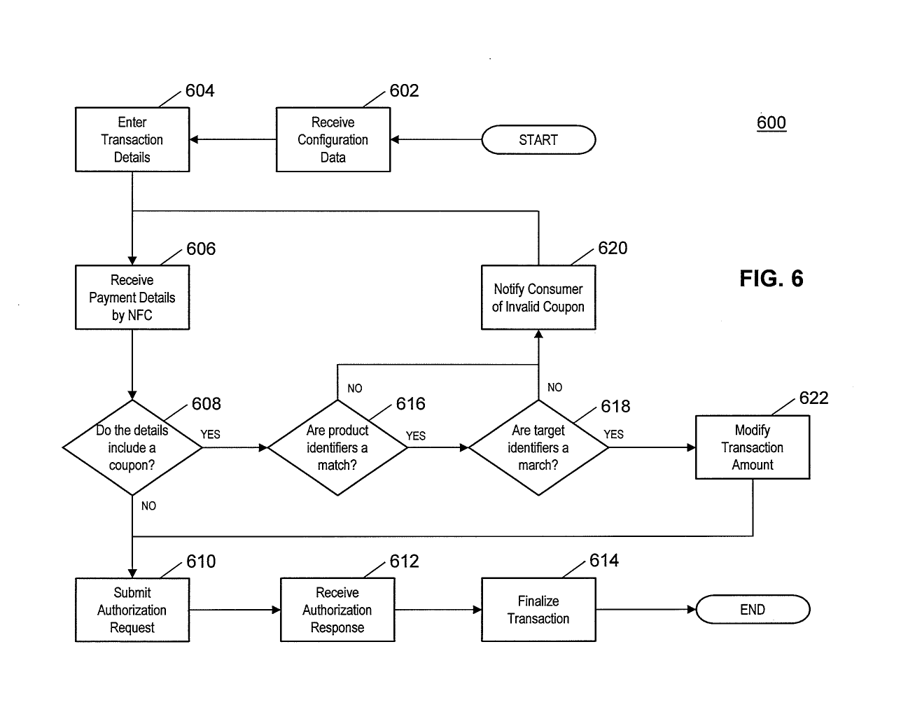

FIG. 6 illustrates a method 600 for the processing of a coupon in a near field transaction by the point of sale system 112.

In step 602, the point of sale system 112 may receive (e.g., via the receiving unit 302) configuration data corresponding to coupons that may be redeemed at the point of sale. The received configuration data may include a plurality of configuration profiles 402, which may be stored (e.g., by the processing unit 308) in the configuration database 114. Each configuration profile 402 may include at least a product identifier and a target identifier.

In step 604, transaction details may be entered into the point of sale system 112 (e.g., via the input unit 306), the transaction details including at least a transaction amount. The entering of transaction details may include reading machine-readable codes (e.g., bar codes) of products, the keying in of information by a user, or other methods as will be apparent to persons having skill in the relevant art. The transaction details may be stored in the transaction database 116.

In step 606, the receiving unit 302 of the point of sale system 112 may receive payment details (e.g., from the mobile device 102) by near field communication (NFC). Methods for the receipt of data using near field communication will be apparent to persons having skill in the relevant art. The payment details may include at least payment information for funding the financial transaction. The payment details may also include at least one coupon record 502, wherein the coupon record 502 includes at least a product identification 504, a target identification 506, and a transaction modifier 508.

In step 608, the processing unit 308 of the point of sale system 112 may determine if the received payment details include the at least one coupon record 502. If the details do not include a coupon record 502, then the process 600 may proceed to step 610. At step 610, the transmitting unit 310 of the point of sale system 112 may submit an authorization request for the financial transaction based on the transaction details entered in step 604, and with the request including the received payment details for the funding of the financial transaction. Configurations of an authorization request will be apparent to persons having skill in the relevant art, such as using the ISO 8583 standard. The authorization request may be submitted to a financial transaction processing agency for processing, such as by utilizing the traditional four-party financial transaction processing system.

In step 612, the receiving unit 302 may receive an authorization response from the financial transaction processing agency. The authorization response may indicate whether the financial transaction is approved or denied. In step 614, the transaction may be finalized. Finalizing of the transaction may include the point of sale system 112 producing a receipt, transmitting a receipt to the mobile device 102 (e.g., via NFC), and/or the merchant furnishing the transacted goods or services to the user of the mobile device 102.

If, in step 608, the processing unit 308 determined that the received payment details did include at least one coupon record 502, then the process 600 may proceed to step 616. In step 616, the processing unit 308 may compare the product identification 504 of the coupon record 502 with the product identifiers 404 of each configuration profile 402 included in the configuration database 114. If the product identification 504 matches at least one product identifier 404, then, in step 618, the processing unit 308 may compare the target identification 506 of the coupon record 502 with the target identifier 406 of each configuration profile 402 where the products matched. In embodiments where a configuration profile 402 may include additional information (e.g., the valid start date 408, maximum amount 412, etc.), steps 616 and 618 may further include the processing unit 308 determining if the additional information in the configuration profile 402 corresponds to the information in the coupon record 502 to determine the validity of the coupon record 502.

If none of the configuration profiles 402 correspond to the at least one coupon record 502, matching both the product identifiers 404 in step 616 or the target identifiers 406 in step 618, then, in step 820, the point of sale system 112 (e.g., or a user of the point of sale system 112, such as a merchant employee) may notify the consumer (e.g., the user of the mobile device 102) of the invalidity of the coupon. In one embodiment, the notification may be transmitted by the point of sale system 112 to the mobile device 102 via NFC for display on the mobile device 102 (e.g., by the display unit 204). The consumer may select a new coupon for use in the transaction or proceed without a coupon, by retransmitting payment details via NFC or informing the user of the point of sale system 112 to proceed without a coupon. The process 600 may then return to step 606, where the point of sale system 112 may receive payment details (e.g., from the mobile device 102 or as input by the user upon removal of the coupon record 502).

If, in steps 616 and 618, the coupon record 502 is determined to correspond to a configuration profile 402, then, in step 622, the processing unit 308 may modify the transaction amount in the transaction database 116 based on the transaction modifier 508 for each valid coupon 502. In some embodiments, the processing unit 308 may store the modified transaction amount in the transaction database 116. Once the transaction amount has been modified, the process 600 may proceed to step 610, where an authorization request for the transaction may be submitted and the transaction finalized as discussed above. In one embodiment, finalizing the transaction when a coupon has been applied may include transmitting a notification of redemption from the point of sale system 112 to the processing server 104 (e.g., for tracking, reporting, updating the quantity of a coupon, providing a receipt to the consumer, etc.) or the mobile device 102 (e.g., to indicate that the coupon record 502 has been redeemed).

### Graphical User Interface of the Mobile Device

FIGS. 7A and 7B illustrate a graphical user interface for an application program on the mobile device 102 for applying a coupon to a near field transaction.

As illustrated in FIG. 7A, the mobile device 102 may display an electronic wallet application program, as described above, via the display unit 204. The display 204 may display a plurality of coupons 502 stored in the stored coupon database 108. As discussed previously, each coupon 502 in the stored coupon database 108 may include coupon data and coupon details. The display 204 may be configured to display only the coupon details for each coupon 502 displayed. In some embodiments, coupons 502 may be displayed based on a predetermined set of criteria, such as merchant name, merchant location, distance to merchant, discount type, discount name, discount value, coupon end date 510, minimum purchase 516, etc. In one embodiment, the display of coupons 502 may be based on preferences set by a user of the mobile device 102.

Each coupon 502 displayed on the display 204 may include at least the transaction modifier 508 and the coupon end date 512, as illustrated in FIG. 7A. In some embodiments, each coupon 502 displayed may be formatted differently based the corresponding coupon details (e.g., the minimum purchase 516 may also be displayed for a coupon if the minimum purchase 516 is not zero). Different types and orientations for the display of coupons 502 on the mobile device 102 will be apparent to persons having skill in the relevant art.

Each coupon 502 may include a save button 702. The save button 702 may, when interacted with by the user (e.g., as identified by the input unit 206), save the corresponding coupon 502. Saving of the coupon 502 may include storing of the corresponding coupon information in the stored coupon database 508 for use in a future financial transaction. Each coupon 502 may also include a share button 704. Interaction with the share button 704 may enable the user of the mobile device 102 to share the corresponding coupon 502 with others, such as notifying another user within the application program, transmitting an e-mail or short message service message to another, posting the coupon 502 to a social network (e.g., Facebook®, Twitter®, etc.), or any other method of sharing as will be apparent to persons having skill in the relevant art.

Each coupon 502 may also include a use button 706. Interaction with the use button 706 may indicate the corresponding coupon 502 to be applied to a financial transaction. Upon receiving the indication by the user (e.g., via the input unit 206), the processing unit 208 may store, in the contactless application 110, coupon data corresponding to the coupon 502. The coupon data stored in the contactless application 110 may include at least the product identification 504, the target identification 506, and the transaction modifier 508. Once a coupon has been indicated for use, the display 204 may display payment and coupon details for use in the financial transaction, as illustrated in FIG. 7B.

In FIG. 7B, the display 204 may display the selected coupon 502 and payment details 708. In an exemplary embodiment, the payment details 708 may be stored in the contactless application 110. The payment details 708 may include a payment method for funding of the financial transaction. In one embodiment, the user of the mobile device 102 may select the payment details 708 prior to the selection of the coupon 502. In another embodiment, the user may select the payment details 708 after the selection of the coupon 502. In an exemplary embodiment, the user may select the payment details 708 from within the same application program as the selection of the coupon. In some embodiments, the display 204 may include buttons for the modifying of payment details 708, the coupon 502 (e.g., for removal of the coupon 502), or the selection of additional coupons. Additional features of the display 204 will be apparent to persons having skill in the relevant art.

The display 204 may also include an enable NFC button 710. The enable NFC button 710 may, when interacted with by the user, activate the transmitting (e.g., by the transmitting unit 210) of the payment and coupon data stored in the contactless application 110, such that it may be received by the point of sale system 112 for the payment of the financial transaction.

### Computer System Architecture

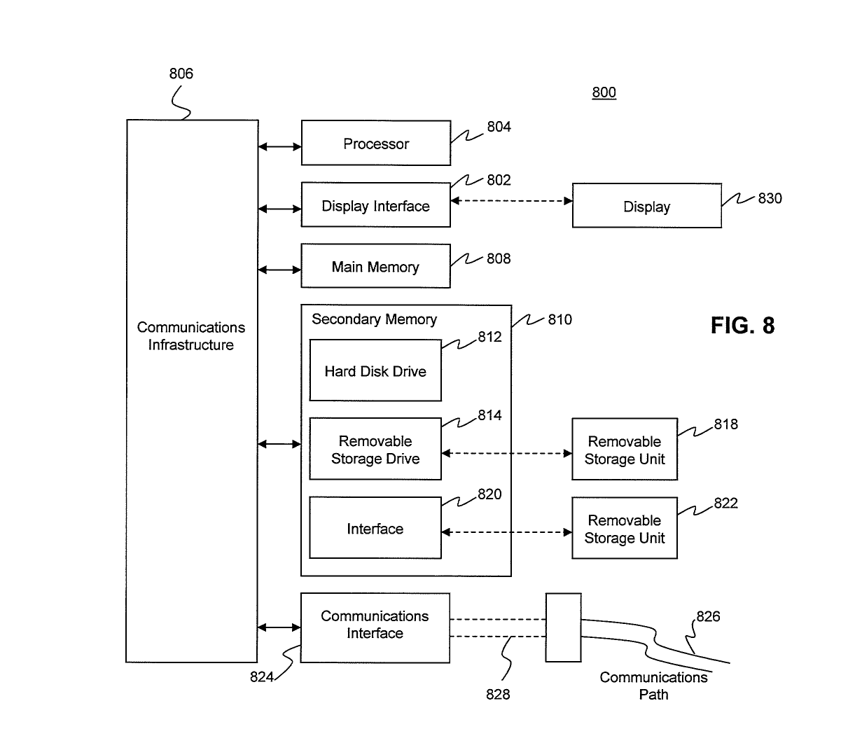

FIG. 8 illustrates a computer system 800 in which embodiments of the present disclosure, or portions thereof, may be implemented as computer-readable code. For example, the mobile device 102, the processing server 104, and the point of sale system 112 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6, 9, and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 118), multi-core message-passing scheme, etc. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 6, 9, and 10, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### Exemplary Method for Processing a Coupon in a Near Field Transaction

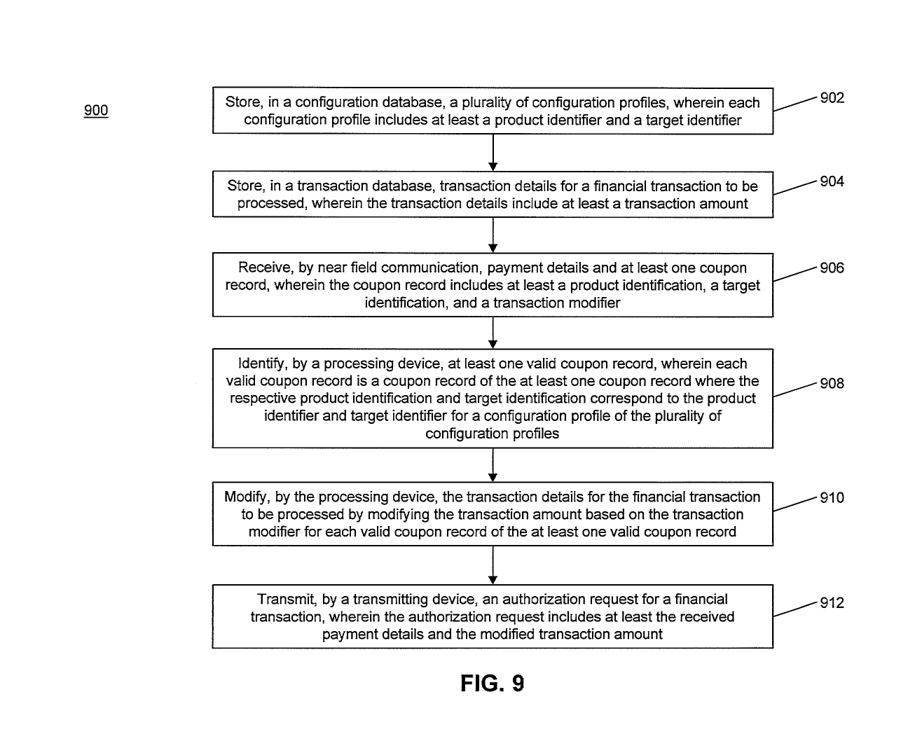

FIG. 9 illustrates a method 900 for processing a coupon in a near field transaction.

In step 902, a plurality of configuration profiles (e.g., configuration profiles 402) may be stored in a configuration database (e.g., the configuration database 114), wherein each configuration profile 402 includes at least a product identifier (e.g., the product identifier 404) and a target identifier (e.g., the target identifier 406). In one embodiment, each configuration profile 402 may further include at least one of a validity start date 408, validity end date 410, maximum dollar amount 412, and maximum percentage 414. In step 904, transaction details for a financial transaction to be processed may be stored in a transaction database (e.g., the transaction database 116), wherein the transaction details include at least a transaction amount.

In step 906, payment details and at least one coupon record (e.g., the coupon record 502) may be received, by near field communication, wherein the coupon record 502 includes at least a product identification (e.g., the product identification 504), a target identification (e.g., the target identification 506), and a transaction modifier (e.g., the transaction modifier 508). In one embodiment, the at least one coupon record 502 may further include at least one of a coupon start date 510, a coupon end date 512, a BIN range 514, a minimum purchase 516, a title, a description, terms and conditions, and a category. In some embodiments, the target identification 506 may be a merchant identification associated with a merchant involved in the financial transaction or an issuer identification associated with an issuer of the respective coupon record 502. In one embodiment, the payment details and at least one coupon record 502 may be encrypted, and step 906 may include decrypting the received payment details and at least one coupon record 502.

In step 908, at least one valid coupon record may be identified by a processing device (e.g., the processing unit 308), wherein each valid coupon record is a coupon record 502 of the at least one coupon record where the respective product identification 504 and target identification 506 correspond to the product identifier 404 and target identifier 406 for a configuration profile 402 of the plurality of configuration profiles. In step 910, the processing device 308 may modify the transaction details for the financial transaction to be processed by modifying the transaction amount based on the transaction modifier 508 for each valid coupon record of the at least one valid coupon record. In step 912, a transmitting device (e.g., the transmitting unit 310) may transmit an authorization request for a financial transaction, wherein the authorization request includes at least the received payment details and the modified transaction amount. In one embodiment, the authorization request may be formatted according to the ISO 8583 standard.

In one embodiment, the method 900 may further include receiving, by a receiving device (e.g., the receiving unit 302) an authorization response indicating approval of the final transaction, and providing a receipt for the financial transaction to a consumer, wherein the receipt indicates the transaction amount, the at least one valid coupon record, and the modified transaction amount. In another embodiment the method 900 may include transmitting, by the transmitting unit 310, an indication of redemption of each valid coupon record of the at least one valid coupon record, wherein the indication of redemption includes at least the product identification 504 of each valid coupon record.

### Exemplary Method for Applying a Coupon in a Near Field Transaction

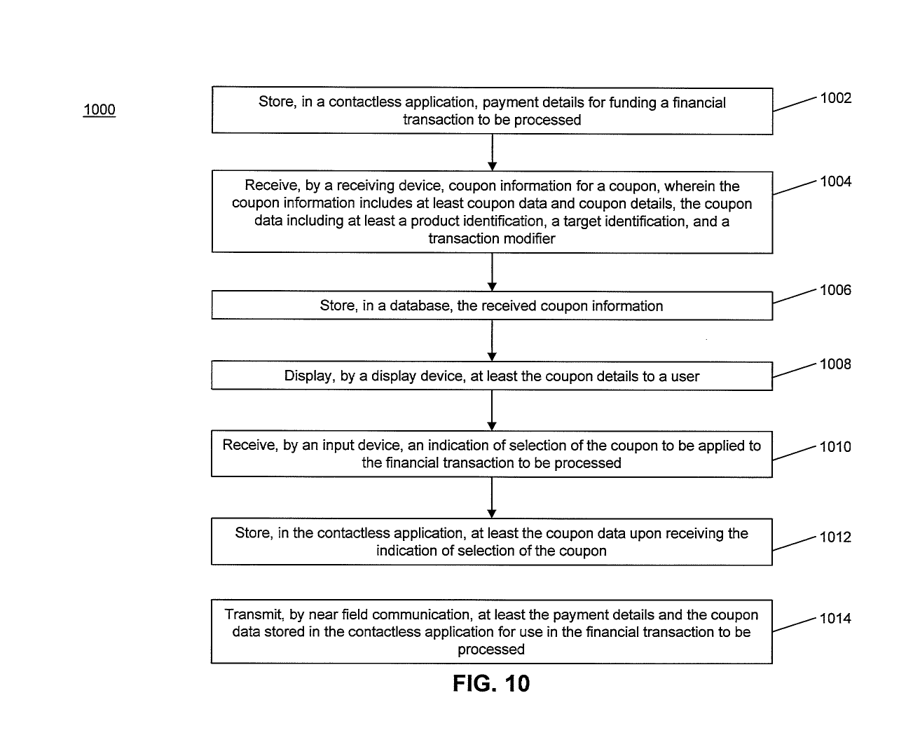

FIG. 10 illustrates a method 1000 for applying a coupon in a near field transaction.

In step 1002, payment details for funding a financial transaction to be processed may be stored in a contactless application (e.g., the contactless application 110). In one embodiment, the contactless application 110 may reside on a non-secure element or a secure element (SE), wherein the secure element may be in a form factor of one of: a subscriber identity module (SIM) card, a Secure Digital (SD) card, and an embedded chip.

In step 1004, a receiving device (e.g., the receiving unit 202) may receive coupon information for a coupon (e.g., the coupon 502), where the coupon information includes at least coupon data and coupon details, the coupon data including at least a product identification (e.g., the product identification 504), a target identification (e.g., the target identification 506), and a transaction modifier (e.g., the transaction modifier 508). In some embodiments, the coupon data may further include at least one of: a coupon start date 510, a coupon end date 512, a BIN range 514, and a minimum purchase amount 516. In some embodiments, the coupon details may include at least one of: a coupon start date 510, a coupon end date 512, a title, a description, terms and conditions a minimum purchase amount 516, a category, a merchant, an issuer, a transaction modifier 508, and an image.

In step 1006, the received coupon information may be stored in a database (e.g., the stored coupon database 108). In step 1008, the coupon details may be displayed to a user by a display device (e.g., the display unit 204). In step 1010, an indication of selection of the coupon 502 to be applied to the financial transaction to be processed may be received by an input device (e.g., the input unit 206). In one embodiment, the input device 206 and the display device 204 may be a single device. In a further embodiment, the single device may be a capacitive touch display.

In step 1012, a processing device (e.g., the processing unit 208) may store, in the contactless application 110, at least the coupon data upon receiving the indication of selection of the coupon 502. In step 1014, a transmitting device (e.g., the transmitting unit 210) may transmit, by near field communication, at least the payment details and the coupon data stored in the contactless application 110 for use in the financial transaction to be processed. In one embodiment, the method 1000 may further include receiving, by the receiving unit 202, a receipt indicating completion of the financial transaction and displaying, on the display device 204, the receipt to the user. In another embodiment, the method 1000 may further include: receiving, by near field communication, a notification of invalidity of the coupon 502; displaying, on the display device 204, the notification of invalidity to the user; receiving, by the input device 206, cancellation of the coupon; and transmitting, by near field communication, the payment details in the contactless application 110 for use in the financial transaction.

Techniques consistent with the present disclosure provide, among other features, systems and methods for the processing of coupons in near field transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method processing a coupon in a near field transaction, comprising:
storing, in a configuration database, a plurality of configuration profiles, wherein each configuration profile includes at least a product identifier 404 and a target identifier;
storing, in a transaction database, transaction details for a financial transaction to be processed, wherein the transaction details includes at least a transaction amount;
receiving, by near field communication (NFC), payment details and at least one coupon record, wherein the coupon record includes at least a product identification, a target identification, and a transaction modifier;
identifying, by a processing device, at least one valid coupon record, wherein each valid coupon record is a coupon record of the at least one coupon record where the respective product identification and target identification correspond to the product identifier and target identifier for a configuration profile of the plurality of configuration profiles;
modifying, by the processing device, the transaction details for the financial transaction to be processed by modifying the transaction amount based on the transaction modifier for each valid coupon record of the at least one valid coupon record; and
transmitting, by a transmitting device, an authorization request for the financial transaction, wherein the authorization request includes at least the received payment details and the modified transaction amount.

2. The method of claim 1, further comprising:
receiving, by a receiving device, an authorization response indicating approval of the financial transaction; and
providing a receipt for the financial transaction to a consumer, wherein the receipt indicates the transaction amount, the at least one valid coupon record, and the modified transaction amount.

3. The method of claim 2, further comprising:
transmitting, by the transmitting device, an indication of redemption of each valid coupon record of the at least one valid coupon record, wherein the indication of redemption includes at least the product identification of each valid coupon record.

4. The method of claim 1, wherein each configuration profile further includes at least one of: a validity start date, a validity end date, a maximum dollar amount, and a maximum percentage.

5. The method of claim 1, wherein each coupon record includes at least one of: a validity start date, a validity end date, a bank identification number (BIN) range, a title, a description, terms and conditions, a minimum purchase amount, and a category.

6. The method of claim 1, wherein the target identification may be a merchant identification associated with a merchant involved in the financial transaction or an issuer identification associated with an issuer of the respective coupon record.

7. The method of claim 1, wherein the payment details and at least one coupon record are encrypted, and wherein receiving the payment details and at least one coupon record through near field communication further includes decrypting the received payment details and at least one coupon record.

8. A method for applying a coupon in a near field transaction, comprising:
storing, in a contactless application, payment details for funding a financial transaction to be processed;
receiving, by a receiving device, coupon information for a coupon, wherein the coupon information includes at least coupon data and coupon details, the coupon data including at least a product identifier, a target identifier, and a transaction modifier;
storing, in a database, the received coupon information;
displaying, by a display device, at least the coupon details to a user;
receiving, by an input device, an indication of selection of the coupon to be applied to the financial transaction to be processed;
storing, in the contactless application, at least the coupon data upon receiving the indication of selection of the coupon; and
transmitting, by near field communication, at least the payment details and the coupon data stored in the contactless application for use in the financial transaction to be processed.

9. The method of claim 8, further comprising:
receiving, by the receiving device, a receipt indicating completion of the financial transaction; and
displaying, on the display device, the receipt to the user.

10. The method of claim 8, further comprising:
receiving, by near field communication, a notification of invalidity of the coupon;
displaying, on the display device, the notification of invalidity to the user;
receiving, by the input device, cancellation of the coupon; and
transmitting, by near field communication, the payment details in the contactless application for use in the financial transaction.

11. The method of claim 8, wherein the coupon data further includes at least one of: a validity start date, a validity end date, a bank identification number (BIN) range, and a minimum purchase amount.

12. The method of claim 8, wherein the coupon details includes at least one of: a validity start date, a validity end date, a title, a description, terms and conditions, a minimum purchase amount, a category, a merchant, an issuer, a transaction modifier, and an image.

13. The method of claim 8, wherein the contactless application resides on a non-secure element or a secure element (SE), wherein the secure element is in a form factor of one of: a subscriber identity module (SIM) card, a Secure Digital (SD) card, and an embedded chip.

14. A system for processing a coupon in a near field transaction, comprising:
a configuration database configured to store a plurality of configuration profiles, wherein each configuration profile includes at least a product identifier and a target identifier;
a transaction database configured to store transaction details for a financial transaction to be processed, wherein the transaction details includes at least a transaction amount;
a receiving device configured to receive, by near field communication, payment details and at least one coupon record, wherein the coupon record includes at least a product identification, a target identification, and a transaction modifier;
a processing device configured to
identify at least one valid coupon record, wherein each valid coupon record is a coupon record of the at least one coupon record where the respective product identification and target identification correspond to the product identifier and target identifier for a configuration profile of the plurality of configuration profiles, and
modify the transaction details for the financial transaction to be processed by modifying the transaction amount based on the transaction modifier for each valid coupon record of the at least one valid coupon record; and
a transmitting device configured to transmit an authorization request for the financial transaction, wherein the authorization request includes at least the received payment details and the modified transaction amount.

15. The system of claim 14, wherein
the receiving device is further configured to receive an authorization respond indicating approval of the financial transaction, and
the transmitting device is configured to transmit, to a consumer, a receipt for the financial transaction, the receipt indicating the transaction amount, the at least one valid coupon record, and the modified transaction amount.

16. The system of claim 15, wherein the transmitting device is further configured to transmit an indication of redemption of each valid coupon record of the at least one valid coupon record, the indication of redemption including at least the product identification of each valid coupon record.

17. The system of claim 14, wherein each configuration profile further includes at least one of: a validity start date, a validity end date, a maximum dollar amount, and a maximum percentage.

18. The system of claim 14, wherein each coupon record includes at least one of: a validity start date, a validity end date, a bank identification number (BIN) range, a title, a description, terms and conditions, a minimum purchase amount, and a category.

19. The system of claim 14, wherein the target identification may be a merchant identification associated with a merchant involved in the financial transaction or an issuer identification associated with an issuer of the respective coupon record.

20. The system of claim 14, wherein the payment details and at least one coupon record are encrypted, and wherein receiving the payment details and at least one coupon record through near field communication further includes decrypting the received payment details and at least one coupon record.

21. A system for applying a coupon in a near field transaction, comprising:
a contactless application configured to store payment details for funding a financial transaction to be processed;
a receiving device configured to receive coupon information for a coupon, the coupon information including at least coupon data and coupon details, wherein the coupon data includes at least a product identifier, a target identifier, and a transaction amount;
a database configured to store the received coupon information;
a display device configured to display at least the coupon details to a user;
an input device configured to receive an indication of selection of a coupon to be applied to the financial transaction to be processed;
a processing device configured to store, in the contactless application, at least the coupon data upon receiving the indication of selection of the coupon; and
a transmitting device configured to transmit, by near field communication, at least the payment details and the coupon data stored in the contactless application for use in the financial transaction to be processed.

22. The system of claim 21, wherein
the receiving device is further configured to receive a receipt indicating completion of the financial transaction; and
the display device is further configured to display the receipt to the user.

23. The system of claim 21, wherein
the receiving device is further configured to receive, by near field communication, a notification of invalidity of the coupon;
the display device is further configured to display the notification of invalidity to the user;
the input device is further configured to receive cancellation of the coupon; and
the transmitting device is further configured to transmit, by near field communication, the payment details in the contactless application for use in the financial transaction.

24. The system of claim 21, wherein the coupon data further includes at least one of: a validity start date, a validity end date, a bank identification number (BIN) range, and a minimum purchase amount.

25. The system of claim 21, wherein the coupon details includes at least one of: a validity start date, a validity end date, a title, a description, terms and conditions, a minimum purchase amount, a category, a merchant, an issuer, a transaction modifier, and an image.

26. The system of claim 21, wherein the contactless application resides on a non-secure element or a secure element (SE), wherein the secure element is in a form factor of one of: a subscriber identity module (SIM) card, a Secure Digital (SD) card, and an embedded chip.
